(19) United States
(12) Patent Application Publication
(10) Pub. No.: US 2020/0136786 A1
(43) Pub. Date: Apr. 30, 2020

(54) DATA TRANSMISSION METHOD, DATA TRANSMISSION FEEDBACK METHOD, AND RELATED APPARATUS

(71) Applicant: HUAWEI TECHNOLOGIES CO., LTD., Shenzhen (CN)

(72) Inventors: Yiqun Wu, Shanghai (CN); Xiuqiang Xu, Shanghai (CN); Lei Wang, Shanghai (CN); Yan Chen, Shanghai (CN)

(21) Appl. No.: 16/723,732

(22) Filed: Dec. 20, 2019

Related U.S. Application Data
(63) Continuation of application No. PCT/CN2018/092502, filed on Jun. 22, 2018.

(30) Foreign Application Priority Data
Jun. 24, 2017 (CN) 201710489650.0

(51) Int. Cl. H04L 5/00; H04L 1/18

(52) U.S. Cl. CPC H04L 5/0055; H04L 5/0094; H04L 5/0005; H04L 1/1812

(57) ABSTRACT

This application discloses a data transmission method, a feedback method, and a related apparatus. The method may include receiving, by a terminal device, feedback configuration information from a network device, where the feedback configuration information indicates a configuration of feedback information specific to uplink data of the terminal device. The method may also include sending, by the terminal device, the uplink data to the network device. Furthermore, the method may include determining, by the terminal device in a feedback message sent by the network device, the feedback information of the uplink data based on the feedback configuration information. In this application, signaling overheads and a transmission latency of data transmission can be reduced.

### CROSS-REFERENCE TO RELATED APPLICATIONS

This application is a continuation of International Application No. PCT/CN2018/092502, filed on Jun. 22, 2018, which claims priority to Chinese Patent Application No. 201710489650.0, filed on Jun. 24, 2017. The disclosures of the aforementioned applications are hereby incorporated by reference in their entireties.

### TECHNICAL FIELD

The present disclosure relates to the communications field, and in particular, to a data transmission method, a data transmission feedback method, and a related device.

### BACKGROUND

In an long term evolution (LTE) communications system, uplink data is transmitted by using a grant based (GB) transmission mechanism. A base station adds feedback information to a physical hybrid automatic repeat request channel (PHICH) to indicate whether the base station correctly receives the uplink data. The feedback information includes acknowledgment (ACK) feedback information and negative ACK (NACK) feedback information. ACK represents that the base station successfully receives and demodulates the uplink data, and NACK represents that the base station does not successfully receive the uplink data. On the PHICH, feedback information of different uplink data is multiplexed in a code division multiple access manner.

In a fifth generation (5G) communications system, the industry is considering a technology in which the base station sends feedback information of a plurality of user equipment (UE) by using a bitmap. In prior techniques, the feedback information of the plurality of UEs is sent by using the bitmap, each UE determines, based on an index of a pilot sequence and an index of a time-frequency resource block that are of the UE, a location of feedback information of the UE in the bitmap, and the UE determines, based on the feedback information, whether retransmission needs to be performed. A problem in this solution is that each UE needs to know related information, such as a global quantity of UE pilot sequences and a quantity of time-frequency resource blocks, to calculate the location of the feedback information in the bitmap. Therefore, the base station needs to send additional signaling to notify each UE of the global quantity of pilot sequences and the global quantity of time-frequency resource blocks. Consequently, signaling overheads and a transmission latency are increased.

### SUMMARY

A technical problem resolved in this application is that a data transmission method, a data transmission feedback method, and a related device are provided, to reduce signaling overheads and a transmission latency of data transmission.

According to a first aspect, this application provides a data transmission method. The method includes: receiving, by a terminal device, feedback configuration information from a network device, where the feedback configuration information is used to indicate a configuration of feedback information specific to uplink data of the terminal device; sending, by the terminal device, the uplink data to the network device; and determining, by the terminal device in a feedback message sent by the network device, the feedback information of the uplink data based on the feedback configuration information.

The feedback configuration information indicates the configuration of the feedback information of the uplink data of the terminal device, for example, a location, a length, or another parameter of the feedback information sent to the terminal device in the feedback message sent by the network device. The feedback message includes feedback information of one or more different terminal devices, or may include feedback information to a plurality of pieces of uplink data of one terminal device. The feedback information indicates a receiving status, to be specific, whether the network device successfully receives the uplink data sent by the terminal device. The receiving status is classified into three cases. 1. The network device receives the uplink data sent by the terminal device and successfully demodulates the uplink data. 2. The network device receives the uplink data sent by the terminal device but fails to demodulate the uplink data. 3. The network device does not receive the uplink data sent by the terminal device. The network device may use different bit values to represent different results. For example, one bit is used to represent the feedback information, “0” indicates two cases: one is that the network device receives the uplink data and successfully demodulates uplink data, and another is that the network device does not receive the uplink data, and “1” indicates that the network device receives the uplink data but fails to demodulate the uplink data. For another example, two bits are used to represent the feedback information, “00” indicates that the network device does not receive the uplink data, “01” indicates that the network device receives the uplink data but fails to demodulate the uplink data, and “11” indicates that the network device receives the uplink data and successfully demodulates the uplink data. A granularity of the uplink data is not limited in this embodiment, and the terminal device may send uplink data of different granularities to the network device based on different service types.

It should be noted that the network device further needs to allocate a transmission resource to the terminal device. The terminal device sends the uplink data based on the transmission resource allocated by the network device. The transmission resource includes but is not limited to one or more of a time-frequency resource, an RS, a spread spectrum sequence, a scrambling code, an interleaved pattern, and a codebook. The network device may allocate the transmission resource to the terminal device in a manner of sending uplink resource configuration information to the terminal device, and the uplink resource configuration information may be carried in higher layer signaling or a physical control message.

By implementing this embodiment of this application, the terminal device learns, based on the feedback configuration information sent by the network device, the configuration of the feedback information. When needing to send the uplink data to the network device, the terminal device can directly obtain, based on the feedback configuration information, the feedback information from the feedback message sent by the network device specific to the uplink data, and determine, based on the feedback information, whether retransmission needs to be performed. In this way, the terminal device simultaneously obtains, in a explicit manner, the feedback information from a specified location in the feedback message sent by the network device, and does not need to obtain a location of the feedback information based on a global quantity of pilot sequences and global resource information that are allocated by the network device. Therefore, signaling overheads and a latency of data transmission are reduced.

In a possible embodiment of the first aspect, the feedback configuration information includes one or more of a quantity of bits occupied by the feedback information in the feedback message, a feedback time interval of the feedback information, and a location index of the feedback information in the feedback message.

The quantity of bits represents a quantity of bits occupied by the feedback information in the feedback message. The feedback time interval of the feedback information represents a time interval between sending the uplink data by the terminal device to receiving the feedback information sent by the network device, and a smallest unit of the feedback time interval is generally a length of one subframe. The location index represents a start bit location of the feedback information sent to the terminal device in the feedback message.

In a possible embodiment of the first aspect, the receiving, by a terminal device, feedback configuration information from a network device includes:

receiving, by the terminal device from a network device, higher layer signaling that carries the feedback configuration information.

The higher layer signaling is signaling above a physical layer, and the higher layer signaling includes but is not limited to at least one of medium access control (MAC) signaling and radio resource control (RRC) signaling.

The higher layer signaling may further carry the uplink resource configuration information. The uplink resource configuration information indicates a configuration of the transmission resource allocated to the uplink data of the terminal device. The terminal device determines, based on the uplink resource configuration information, the transmission resource allocated to the uplink data, and the terminal device sends the uplink data to the network device based on the allocated transmission resource. The transmission resource includes but is not limited to one or more of a time-frequency resource, a reference signal, a spread spectrum sequence, an interleaved pattern, a scrambling code, and a codebook.

In a possible embodiment of the first aspect, before the sending, by the terminal device, the uplink data to the network device, the method further includes:

receiving, by the terminal device, activation instruction information from the network device; and

activating, by the terminal device according to the activation instruction information, the configuration indicated by the feedback configuration information.

After activating the feedback configuration information, the terminal device can determine, in the feedback message sent by the network device, the feedback information by using the configuration indicated by the feedback configuration information. It should be noted that the activation instruction information may further instruct the terminal device to activate the configuration indicated by the uplink resource configuration information. After the configuration indicated by the uplink resource configuration information is activated, the terminal device can send the uplink data by using the transmission resource indicated by the uplink resource configuration information. Optionally, the activation instruction information may be carried in downlink control information (DCI) delivered by the network device.

In a possible embodiment of the first aspect, the receiving, by a terminal device, feedback configuration information from a network device includes: receiving, by the terminal device, DCI that carries the feedback configuration information and that is sent by the network device.

The DCI further carries the activation instruction information. The terminal device receives the DCI that carries the feedback configuration information and the activation instruction information. The terminal device activates the feedback configuration information according to the activation instruction information. Only after the feedback configuration information is activated, the terminal device can determine, in the feedback message sent by the network device specific to the uplink data, the feedback information by using the feedback configuration information.

The terminal device further receives the higher layer signaling that carries the uplink resource configuration information and that is sent by the network device. The uplink resource configuration information is used to indicate the configuration of the transmission resource allocated by the network device to the uplink data. It should be noted that the activation instruction information may further be used to instruct the terminal device to activate the configuration indicated by the uplink resource configuration information.

In a possible embodiment of the first aspect, the receiving, by a terminal device, the configuration information from a network device includes: receiving, by the terminal device, higher layer signaling that carries first feedback configuration information, where the first feedback configuration information includes some parameters in the feedback configuration information; and receiving, by the terminal device, DCI that carries second feedback configuration information, where the second feedback configuration information includes the other parameters in the feedback configuration information. The terminal device combines the first feedback configuration information and the second feedback configuration information to obtain the complete feedback configuration information. The first feedback configuration information and the second feedback configuration information jointly indicate the configuration of the feedback information specific to the uplink data of the terminal device.

The higher layer signaling may further carry the uplink resource configuration information. The uplink resource configuration information indicates the configuration of the transmission resource allocated by the network device to the uplink data. The terminal device sends the uplink data to the network device based on the allocated transmission resource.

In a possible embodiment of the first aspect, the feedback message is specifically common downlink control information Common DCI.

According to a second aspect, this application provides a data transmission feedback method. The method includes:

sending, by a network device, feedback configuration information to a terminal device, where the feedback configuration information is used to indicate a configuration of feedback information specific to uplink data of the terminal device; receiving, by the network device, the uplink data from the terminal device; and sending, by the network device, a feedback message based on the configuration of the feedback information specific to the uplink data of the terminal device, where the feedback message carries the feedback information of the uplink data.

It should be noted that the network device further sends uplink resource configuration information to the terminal device. The uplink resource configuration information indicates a configuration of a transmission resource allocated to the uplink data of the terminal device. The terminal device sends the uplink data to the network device based on the transmission resource indicated by the uplink resource configuration information.

In a possible embodiment of the second aspect, the sending, by a network device, feedback configuration information to a terminal device includes: sending, by the network device to the terminal device, higher layer signaling that carries the feedback configuration information. The higher layer signaling is signaling above a physical layer, and the higher layer signaling includes but is not limited to MAC signaling or RRC signaling.

The higher layer signaling may further carry the uplink resource configuration information. The uplink resource configuration information indicates the configuration of the transmission resource allocated to the uplink data of the terminal device. The terminal device sends the uplink data to the network device based on the transmission resource indicated by the uplink resource configuration information.

In a possible embodiment of the second aspect, before the receiving, by the network device, the uplink data from the terminal device, the method further includes:

sending, by the network device, activation instruction information to the terminal device, where the activation instruction information is used to instruct the terminal device to activate the configuration indicated by the feedback configuration information. The activation instruction information may be carried in DCI sent by the network device.

The network device may further send, to the terminal device, the higher layer signaling that carries the uplink resource configuration information. The uplink resource configuration information indicates the configuration of the transmission resource allocated to the uplink data of the terminal device. The terminal device sends the uplink data to the network device based on the transmission resource indicated by the uplink resource configuration information.

In a possible embodiment of the second aspect, the sending, by a network device, the feedback configuration information to a terminal device includes: sending, by the network device to the terminal device, DCI that carries the feedback configuration information.

The DCI may further carry the activation instruction information. The activation instruction information is used to instruct the terminal device to activate the configuration indicated by the feedback configuration information carried in the DCI.

The network device further sends, to the terminal device, the higher layer signaling that carries the uplink resource configuration information. The uplink resource configuration information is used to indicate the transmission resource allocated to the uplink data of the terminal device by the network device. The activation instruction information may further instruct the terminal device to activate the configuration indicated by the uplink resource configuration information.

In a possible embodiment of the second aspect, the sending, by a network device, feedback configuration information to a terminal device includes: sending, by the network device to the terminal device, higher layer signaling that carries first feedback configuration information, where the first feedback configuration information includes some parameters in the feedback configuration information; and sending, by the network device to the terminal device, DCI that carries second feedback configuration information, where the second feedback configuration information includes the other parameters in the feedback configuration information. The first feedback configuration information and the second feedback configuration information form the complete feedback configuration information. The first feedback configuration information and the second feedback configuration information jointly indicate the configuration of the feedback information specific to the uplink data of the terminal device.

The higher layer signaling may further carry the uplink resource configuration information. The uplink resource configuration information indicates the configuration of the transmission resource allocated to the uplink data of the terminal device. The terminal device sends the uplink data to the network device based on the transmission resource indicated by the uplink resource configuration information.

In a possible embodiment of the second aspect, the feedback message is specifically common downlink control information Common DCI.

By implementing this embodiment of this application, the terminal device learns, based on the feedback configuration information sent by the network device, the configuration of the feedback information. When needing to send the uplink data to the network device, the terminal device can directly obtain, based on the feedback configuration information, the feedback information from the feedback message sent by the network device specific to the uplink data, and determine, based on the feedback information, whether retransmission needs to be performed. In this way, the terminal device simultaneously obtains, in a explicit manner, the feedback information from a specified location in the feedback message sent by the network device, and does not need to obtain a location of the feedback information based on a global quantity of pilot sequences and global resource information that are allocated by the network device. Therefore, signaling overheads and a latency of data transmission are reduced.

According to still another aspect, a data transmission apparatus is provided. The data transmission apparatus has a function of implementing behavior of a terminal device in the foregoing method. The function may be implemented by hardware, or may be implemented by hardware by executing corresponding software. The hardware or software includes one or more modules corresponding to the foregoing function.

In a possible embodiment, the data transmission apparatus includes a receiving unit, a sending unit, and a determining unit.

The receiving unit is configured to receive feedback configuration information from a network device. The feedback configuration information is used to indicate a configuration of feedback information specific to uplink data of a terminal device.

The sending unit is configured to send the uplink data to the network device.

The determining unit is configured to determine, in a feedback message sent by the network device, the feedback information of the uplink data based on the feedback configuration information.

In another possible embodiment, the data transmission apparatus includes a transceiver, a memory, and a processor.

The transceiver is configured to: receive the feedback configuration information from the network device, where the feedback configuration information is used to indicate the configuration of the feedback information specific to the uplink data of the terminal device; and send the uplink data to the network device.

The memory stores a group of program code. The processor is configured to invoke the program code stored in the memory to perform the following operation: determining, in the feedback message sent by the network device, the feedback information of the uplink data based on the feedback configuration information.

Based on a same invention concept, for a problem resolving principle and beneficial effects of the apparatus, refer to the foregoing possible method embodiments of the terminal device and beneficial effects that are brought about. Therefore, for embodiment of the apparatus, refer to the embodiment of the method. Repeated parts are not described again.

According to still another aspect, a data transmission feedback apparatus is provided. The data transmission feedback apparatus has a function of implementing behavior of a network device in the foregoing method. The function may be implemented by hardware, or may be implemented by hardware by executing corresponding software. The hardware or software includes one or more modules corresponding to the foregoing function.

In a possible embodiment, the data transmission feedback apparatus includes a receiving unit and a sending unit.

The sending unit is configured to send feedback configuration information to a terminal device. The feedback configuration information is used to indicate a configuration of feedback information specific to uplink data of the terminal device.

The receiving unit is configured to receive the uplink data from the terminal device.

The sending unit is further configured to send a feedback message based on the configuration of the feedback information specific to the uplink data of the terminal device. The feedback message carries the feedback information of the uplink data.

In another possible embodiment, the data transmission feedback apparatus includes a transceiver.

The transceiver is configured to: send the feedback configuration information to the terminal device, where the feedback configuration information is used to indicate the configuration of the feedback information specific to the uplink data of the terminal device;

receive the uplink data from the terminal device; and

send the feedback message to the terminal device based on the configuration of the feedback information of the uplink data of the terminal device, where the feedback message carries the feedback information of the uplink data.

Based on a same invention concept, for a problem resolving principle and beneficial effects of the apparatus, refer to the foregoing possible method embodiments of the network device and beneficial effects that are brought about. Therefore, for embodiment of the apparatus, refer to the embodiment of the method. Repeated parts are not described again.

According to another aspect, this application provides a computer readable storage medium. The computer readable storage medium stores an instruction, and when the instruction runs on a computer, the computer is enabled to perform the method according to the foregoing aspects.

According to another aspect, this application a computer program product including an instruction. When the computer program product runs on a computer, the computer is enabled to perform the methods according to the foregoing aspects.

### BRIEF DESCRIPTION OF DRAWINGS

To describe the technical solutions in the embodiments of the present invention or in the background more clearly, the following briefly describes the accompanying drawings required for describing the embodiments of the present invention or the background.

FIG. 1 shows a network architecture of a communications system according to an embodiment of the present invention;

FIG. 2a is a schematic interaction diagram of a data transmission method according to an embodiment of the present invention;

FIG. 2b is a schematic diagram of allocating an uplink time-frequency resource according to an embodiment of the present invention;

FIG. 2c is a schematic structural diagram of a feedback message according to an embodiment of the present invention;

FIG. 3 is another schematic interaction diagram of a data transmission method according to an embodiment of the present invention;

FIG. 4 is another schematic interaction diagram of a data transmission method according to an embodiment of the present invention;

FIG. 5 is another schematic interaction diagram of a data transmission method according to an embodiment of the present invention;

FIG. 6 is another schematic interaction diagram of a data transmission method according to an embodiment of the present invention;

FIG. 7 is a schematic structural diagram of a data transmission apparatus according to an embodiment of the present invention;

FIG. 8 is another schematic structural diagram of a data transmission apparatus according to an embodiment of the present invention;

FIG. 9 is a schematic structural diagram of a data transmission feedback apparatus according to an embodiment of the present invention; and

FIG. 10 is another schematic structural diagram of a data transmission feedback apparatus according to an embodiment of the present invention.

### DESCRIPTION OF EMBODIMENTS

The following describes the embodiments of the present invention with reference to the accompanying drawings in the embodiments of the present invention.

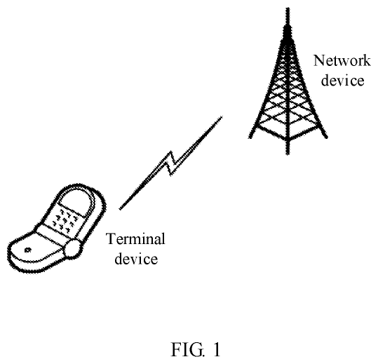

FIG. 1 is a schematic diagram of a network architecture of a communications system according to an embodiment of the present invention. The communications system includes a network device and a terminal device. FIG. 1 shows one network device communicating with one terminal device. The communications system may be a global system for mobile communication global system for mobile communication (GSM), a code division multiple access (CDMA) system, and a wideband code division multiple access (WCDMA) system, a worldwide interoperability for microwave access (WiMAX) system, an LTE system, a 5G communications system (for example, a new radio (NR) system, a communications system that integrates a plurality of communications technologies (for example, a communications system that integrates an LTE technology and an NR technology), or a subsequent evolved communications system). Forms and quantities of the network device and the terminal device shown in FIG. 1 are merely used as an example, and do not constitute a limitation on the embodiments of the present invention.

A terminal device in this application is a device having a wireless communication function, and may be a handheld device having a wireless communication function, a vehicle-mounted device, a wearable device, a computing device, another processing device connected to a wireless modem, or the like. The terminal device may have different names in different networks, for example, a terminal device, an access terminal, a subscriber unit, a subscriber station, a mobile station, a mobile console, a remote station, a remote terminal, a mobile device, a user terminal, a terminal, a wireless communications device, a user agent, a user apparatus, a cellular phone, a cordless phone, a session initiation protocol (SIP) phone, a wireless local loop (WLL) station, a personal digital assistant (PDA), or a terminal device in a 5G network or a future evolved network.

The network device in this application is a device that is deployed in a radio access network to provide a wireless communication function, and includes but is not limited to a base station (for example, a base transceiver station (BTS), a NodeB (NB), an evolved NodeB (eNB or eNodeB), a transmission node or a transmission reception point (TRP or TP) or a next-generation NodeB (gNB) in an NR system, or a base station in a future communications network, a relay node, an access point, a vehicle-mounted device, a wearable device, a wireless fidelity (Wi-Fi) station, a wireless backhaul node, a small cell, a micro base station, or the like.

A current feedback information sending method is as follows: The network device determines a target bit in a bitmap and determines a value of the target bit, the network device sends the bitmap to the terminal device, and the terminal device determines a location of feedback information in the bitmap based on an index of a pilot sequence. It can be learned that in a current feedback method, the network device needs to notify each terminal device of global pilot sequence configuration information and global resource block configuration information, so that the terminal device determines, based on the global pilot sequence configuration information and the global resource block configuration information, the location of the feedback information in the bitmap sent by the network device. The bitmap may be included in downlink control information (DCI) sent by the network device.

The embodiments of the present invention provide a data transmission method. The terminal device learns, based on feedback configuration information sent by the network device, a configuration of feedback information. When needing to send uplink data to the network device, the terminal device can directly obtain, based on the feedback configuration information, the feedback information from a feedback message sent by the network device specific to the uplink data, and determine, based on the feedback information, whether retransmission needs to be performed. In this way, the terminal device simultaneously obtains, in an explicit manner, the feedback information from a specified location in the feedback message sent by the network device, and does not need to obtain the location of the feedback information based on a global quantity of pilot sequences and global resource information that are allocated by the network device. Therefore, signaling overheads and a latency of data transmission are reduced.

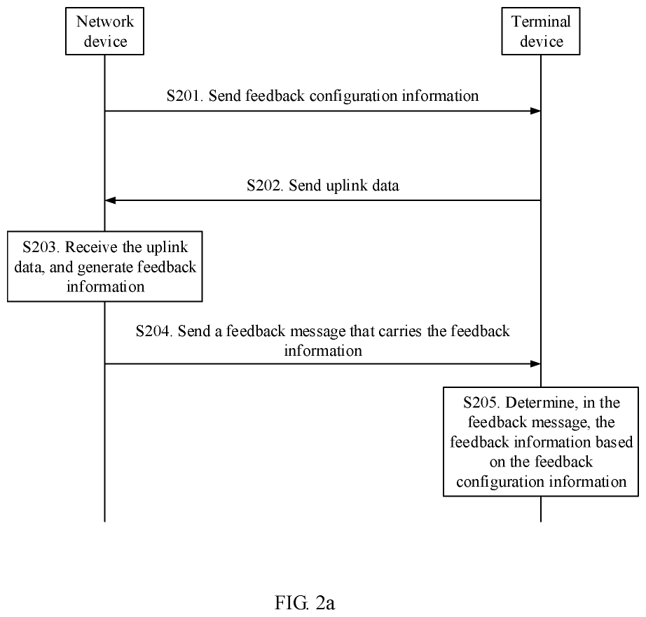

FIG. 2a shows a data transmission method according to an embodiment of the present invention. The method includes but is not limited to the following steps.

S201. A network device sends feedback configuration information to a terminal device, and the terminal device receives the feedback configuration information sent by the network device.

The feedback configuration information is used to indicate a configuration of feedback information specific to uplink data of the terminal device, and the terminal device determines, based on the feedback configuration information, the feedback information sent to the terminal device in a feedback message (for example, DCI) sent by the network device. The feedback message includes feedback information sent to a plurality of different terminal devices. The feedback information indicates a status of receiving, by the network device, the uplink data sent by the terminal device. The feedback information may indicate three receiving statuses: successful demodulation of the uplink data, failed demodulation of the uplink data, and a failure in receiving the uplink data.

Optionally, the network device sends, to the terminal device, higher layer signaling that carries the feedback configuration information, and the terminal device may obtain the feedback configuration information from the higher layer signaling sent by the network device. The higher layer signaling is signaling above a physical layer, and the higher layer signaling includes but is not limited to an RRC message and a MAC message. For example, the RRC message includes any one of a radio resource control connection reconfiguration (RRC Connection Reconfiguration) message, a radio resource control connection reestablishment (RRC Connection Reestablishment) message, a radio resource control connection establishment (RRC Connection Setup) message, and an RRC connection resume message.

Optionally, the network device sends, to the terminal device, DCI that carries the feedback configuration information, and the terminal device obtains the feedback configuration information from the DCI.

Optionally, the feedback configuration information includes a plurality of parameters. The network device sends, to the terminal device, higher layer signaling that carries first feedback configuration information, and sends, to the terminal device, DCI that carries second feedback configuration information. The terminal device obtains the first feedback configuration information from the higher layer signaling, and obtains the second feedback configuration information from the DCI. The terminal device obtains the feedback configuration information based on the first feedback configuration information and the second feedback configuration information, and the first feedback configuration information and the second feedback configuration information jointly indicate the configuration of the feedback information specific to the uplink data of the terminal device. The first feedback configuration information includes some parameters in the feedback configuration information, and the second feedback configuration information includes the other parameters in the feedback configuration information.

S202. The terminal device sends the uplink data to the network device, and the network device receives the uplink data sent by the terminal device.

The terminal device needs to send the uplink data to the network device by using a transmission resource. The transmission resource used to send the uplink data is allocated by the network device. The terminal device may send the uplink data to the network device by using a GB transmission mechanism (or referred to as a GB transmission mode), or may send the uplink data to the network device by using a grant-free (GF) transmission mechanism (or referred to as a GF transmission mode). When a plurality of terminal devices communicate with the network device, some terminal devices may send uplink data to the network device by using the GB transmission mechanism, and the other terminal devices may send uplink data to the network device by using the GF transmission mechanism. In the GB transmission mechanism, before transmitting the uplink data, the terminal device needs to send an uplink scheduling request to the network device, the network device sends an uplink grant (UL grant) to the terminal device based on the scheduling request sent by the terminal device, so as to instruct to allocate, to the terminal device, the transmission resource used to transmit the uplink data, and only after receiving the uplink grant, the terminal device transmits the uplink data by using the transmission resource indicated by the uplink grant. In the GF transmission mechanism, before transmitting the uplink data, the terminal device does not need to send the scheduling request to the network device, but transmits the uplink data to the network device by using a transmission resource pre-allocated by the network device. In the GB transmission mechanism, the terminal device can transmit the uplink data without an uplink grant from the network device. In this embodiment of the present invention, uplink data transmitted by using the GB transmission mechanism is referred to as GB data, and uplink data transmitted by using the GF transmission mechanism is referred to as GF data. The network device receives the uplink data sent by the terminal device, where the uplink data may be GB data, or may be GF data. It should be noted that when the uplink data sent by the terminal device to the network device includes both the GB data and the GF data, the network device separately generates different feedback information based on the GB data and the GF data. Feedback information to the GB data and feedback information to the GF data are at different locations in the feedback message generated by the network device.

When the uplink data is the GB data, before sending the uplink data, the terminal device needs to send the uplink scheduling request to the network device. The uplink scheduling request is used to request, from the network device, the transmission resource for transmitting the uplink data. The network device determines, based on parameters such as a data volume, a service type, and a priority of the uplink data, whether to allocate the transmission resource to the terminal device. If the network device determines to allocate the transmission resource to the terminal device, the network device sends the uplink grant to the terminal device, and the terminal device sends the uplink data to the network device after receiving the uplink grant.

When the uplink data is the GF data, the terminal device does not need to obtain a grant of the network device specific to this uplink data transmission, and directly uses the transmission resource that is preconfigured by the network device for the terminal device and that is used to send the uplink data. When preconfiguring, for the terminal device, the transmission resource used to transmit the uplink data, the network device may send uplink resource configuration information. The uplink resource configuration information indicates the transmission resource that is allocated to the terminal device to transmit the uplink data. The terminal device sends the uplink data based on the transmission resource indicated by the uplink resource configuration information. The transmission resource includes but is not limited to one or more of a time-frequency resource, a reference signal, a spread spectrum sequence, a scrambling code, and a codebook. The network device may allocate one time-frequency resource block (RB) to the terminal device in each transmission time interval (TTI), or allocate a plurality of time-frequency resource blocks to the terminal device in each TTI, or allocate one time-frequency resource block to the terminal device in a plurality of TTIs, in other words, periodically allocate one time-frequency resource block to the terminal device. This is not limited in this embodiment. The network device allocates time-frequency resource blocks on different subcarriers to the terminal device, to implement frequency hopping and obtain a frequency diversity gain. In this way, transmission reliability is improved.

For example, referring to FIG. 2b, a shadow grid in FIG. 2b represents a time-frequency resource that can be allocated to the terminal device, a horizontal coordinate represents time domain, and numbers n, n+1, n+2, and n+3 each represent sequence numbers of subframes (TTIs or slots). A vertical coordinate represents frequency domain, and #1, #2, #3, and #4 represent sequence numbers of subbands. A bandwidth of a subband is not limited in this embodiment, and is also set according to a requirement. For example, the bandwidth of the subband is bandwidth of 12 subcarriers. In a communications system, a TTI is one subframe. The network device allocates one time-frequency resource block to the terminal device in each subframe. To be specific, the network device allocates, to the terminal device in a subframe n, a time-frequency resource block corresponding to a subband #1, allocates, to the terminal device in a subframe n+1, a time-frequency resource block corresponding to a subband #3, allocates, to the terminal device in a subframe n+2, a time-frequency resource block corresponding to subband #2, and allocates, to the terminal device in a subframe n+3, a time-frequency resource block corresponding to subband #4. The network device allocates a time-frequency resource block of a different frequency band to the terminal device in each TTI, to implement a frequency diversity gain. In this way, data transmission reliability is improved.

In a possible embodiment, the network device may allocate a same time-frequency resource block to a plurality of different terminal devices, and then distinguish the different terminal devices by using different reference signals (RS). The transmission resource of the terminal device includes a time-frequency resource and a reference signal, and the network device needs to number the reference signals that are of the different terminal devices and that are in the time-frequency resource block.

A possible numbering method is: defining a number of the transmission resource, and determining a number of the time-frequency resource block and a number of the reference signal by using the number of the transmission resource. For example, each TTI is corresponding to K time-frequency resource blocks, and each time-frequency resource block includes L different reference signals. In this case, there are K×L transmission resources in each TTI, and a range of numbers of the transmission resources is 1 to K×L.

Another possible numbering method is: separately defining a number of the time-frequency resource block and a number of the reference signal, and determining a number of an uplink resource based on the two numbers. For example, each TTI is corresponding to K time-frequency resource blocks, and each time-frequency resource block includes L different reference signals. In this case, a number of a transmission resource is (i, j), 1≤i≤K, 1≤j≤L, and i and j are integers.

Optionally, the network device may further configure a physical layer parameter for the terminal device. The physical layer parameter includes but is not limited to one or more of a modulation and coding mode, a redundancy version, a reference signal sequence parameter (for example, a root of a Zadoff-Chu (ZC) sequence), or a cyclic shift parameter of a reference signal sequence.

S203. The network device receives the uplink data, and generates the feedback information.

When the network device receives the uplink data sent by the terminal device, three cases may occur. 1. The network device does not detect the uplink data sent by the terminal device, in other words, the network device does not receive the uplink data. 2. The network device detects the uplink data sent by the terminal device (in other words, the network device receives the uplink data sent by the terminal device), but the network device fails to demodulate the received uplink data. 3. The network device detects the uplink data sent by the terminal device (in other words, the network device receives the uplink data sent by the terminal device), and the network device successfully demodulates the received uplink data. For the foregoing three receiving cases, the network device may generate the feedback information to indicate, to the terminal device, a status of receiving, by the network device, the uplink data transmitted by the terminal device. The feedback information may indicate three statuses: successful demodulation of the uplink data, failed demodulation of the uplink data, and a failure in receiving the uplink data. The successful demodulation of the uplink data represents that the network device receives the uplink data sent by the terminal device and successfully demodulates the uplink data; the failed demodulation of the uplink data represents that the network device receives the uplink data sent by the terminal device but fails to demodulate the uplink data; and the failure in receiving the uplink data represents that the network device does not detect the uplink data sent by the terminal device.

In a possible embodiment, the network device may use one bit to represent the feedback information. For example, when the bit of the feedback information is “1”, it represents that the network device successfully demodulates the uplink data; or when the bit of the feedback information is “0”, it represents that the network device fails to demodulate the uplink data or does not receive the uplink data.

In another possible embodiment, the network device may use two bits to represent the feedback information. For example, when the bits of the feedback information are “00”, it indicates that the network device does not receive the uplink data; “01” indicates that the network device receives the uplink data but fails to demodulate the uplink data; and “11” indicates that the network device receives the uplink data and successfully demodulates the uplink data.

It should be noted that a correspondence between a bit value and a meaning represented by the feedback information is not limited to the foregoing example, and may be set according to a requirement. This is not limited in this embodiment.

S204. The network device sends, to the terminal device, the feedback message that carries the feedback information, and the terminal device receives the feedback message sent by the network device.

The feedback message may be DCI, and the DCI includes a field used to perform feedback on uplink data transmission. In an embodiment, the feedback message may be specifically common DCI. The common DCI is DCI specific to a plurality of terminal devices (or a group of terminal devices), and one piece of common DCI includes information specific to the plurality of terminal devices (or the group of terminal devices). The common DCI may be used to perform feedback on uplink data transmission performed by using a plurality of hybrid automatic repeat request (HARQ) processes of a same terminal device, or perform feedback on uplink data transmission of a plurality of terminal devices. In this embodiment of the present invention, the common DCI includes feedback information specific to uplink data transmission of the plurality of terminal devices, the plurality of terminal devices include the terminal device that sends the uplink data in S203, and the feedback information sent to the plurality of terminal devices is at different locations in the feedback message.

In an embodiment, when a terminal device simultaneously sends a plurality of pieces of uplink data by using a plurality of HARQ processes, the network device may perform feedback on uplink data sent by using each HARQ process of the terminal device. Feedback information specific to uplink data transmission of the terminal device includes feedback information specific to the uplink data sent by using each HARQ process of the terminal device. Feedback information corresponding to different HARQ processes of the terminal device is at different locations in the feedback message. In another embodiment, the network device may alternatively perform feedback, in a feedback message, on a plurality of pieces of uplink data sent by a same terminal in different slots. Feedback information of uplink data transmission of the terminal device includes feedback information specific to the plurality of pieces of uplink data sent by the terminal device in the different slots. The feedback information corresponding to the uplink data sent by the terminal device in the different slots is at different locations in the feedback message.

In an embodiment, in one slot, if only one terminal device in the plurality of terminal devices (or the group of terminal devices) corresponding to the common DCI sends uplink data, the network device may either use UE-specific DCI or use the common DCI to feed back, to the terminal that sends the uplink data, a receiving status of uplink data transmission of the terminal device. In this embodiment, when the common DCI is used to feed back the receiving status of the uplink data transmission, in a feedback message, a field corresponding to feedback information corresponding to a terminal device that does not send data may be set to a default value (for example, be set to “0”). Using the UE-specific DCI to feed back the receiving status of the uplink data transmission is used in some prior systems, and details are not described herein again.

The feedback message may be sent on a physical downlink control channel (PDCCH) or an enhanced physical downlink control channel (EPDCCH).

S205. The terminal device determines, in the feedback message, the feedback information based on the feedback configuration information.

The terminal device determines, in the feedback message based on the configuration indicated by the feedback configuration information received in S201, the receiving status indicated by the feedback information, and determines, based on the receiving status indicated by the feedback information, whether to perform retransmission. When the feedback information indicates that the uplink data is successfully demodulated, the terminal device sends new uplink data. When the feedback information indicates that the uplink data fails to be demodulated or the uplink data is not received, the terminal device retransmits the uplink data.

Optionally, the feedback configuration information includes one or more of a quantity of bits occupied by the feedback information in the feedback message, a feedback time interval, and a location index of the feedback information in the feedback message.

The quantity of bits represents a quantity of bits occupied by the feedback information in the feedback message. The feedback time interval represents a time interval between sending the uplink data and receiving the feedback information by the terminal device. The location index represents a location of the feedback information sent to the terminal device in the feedback message sent by the network device.

For example, referring to FIG. 2c, the feedback message sent by the network device includes 16 bits. The terminal device receives the feedback message sent by the network device, and learns, through parsing, that the feedback message sent by the network device is “100010100000000100”, which are a zeroth bit to a 15th respectively from left to right. The feedback configuration information includes the quantity of bits and the location index. The terminal device receives the feedback configuration information sent by the network device, and learns, through parsing, that the feedback configuration information sent by the network device is “ANIndex=4, ANLength=2”. “ANIndex=4” indicates that the feedback information is located at a fourth bit of the feedback message, and “ANLength=2” indicates that the quantity of bits of the feedback information is 2. Therefore, it can be learned that the bits of the feedback information sent to the terminal device are “01”. According to an example in S203, the terminal device determines that the feedback information indicates that the uplink data is received but the uplink data fails to be demodulated, and the terminal device resends the uplink data. “FreqResource=2” is the uplink resource configuration information of the terminal device, and “FreqResource=2” indicates that a second time-frequency resource block in each subframe is allocated to the uplink data.

For example, if a minimum granularity of the feedback time interval is one subframe, the feedback time interval is an integer multiple of a length of the subframe, and the feedback time interval is a length of one subframe, the terminal device sends the uplink data in a subframe n, and then the terminal device receives, in a subframe n+1, the feedback message sent by the network device.

In an embodiment, the feedback configuration information may be used to configure the feedback information of uplink data transmission performed by using each HARQ process of the terminal device. For example, one or more of a feedback time interval of the feedback information, a quantity of bits occupied by the feedback information in the feedback message, and a location index of the feedback information in the feedback message may be configured for the uplink data transmission performed by using each HARQ process of the terminal device.

In the method described in FIG. 2a, the terminal device learns, based on the feedback configuration information sent by the network device, a configuration of the feedback information. When needing to send the uplink data to the network device, the terminal device can directly obtain, based on the feedback configuration information, the feedback information from the feedback message sent by the network device specific to the uplink data, and determine, based on the feedback information, whether retransmission needs to be performed. In this way, the terminal device directly obtains the feedback information from a specified location in the feedback message sent by the network device, and does not need to obtain a location of the feedback information based on a global quantity of pilot sequences and global resource information that are allocated by the network device. Therefore, signaling overheads and a latency of data transmission are reduced.

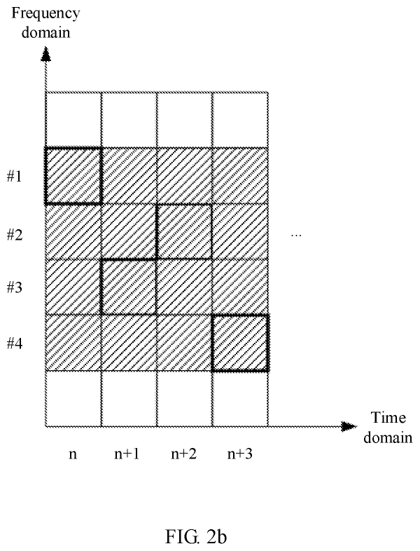

FIG. 3 is another schematic flowchart of a data transmission method according to an embodiment of the present invention. In this embodiment of the present invention, the method includes the following steps.

S301. A network device sends higher layer signaling that carries feedback configuration information and uplink resource configuration information, and a terminal device receives the higher layer signaling sent by the network device.

The feedback configuration information is used to indicate a configuration of feedback information specific to uplink data of the terminal device, and the terminal device determines, based on the feedback configuration information, the feedback information sent to the terminal device in a feedback message sent by the network device. For example, the feedback configuration information includes one or more of a quantity of bits, a feedback time interval, and a location index. The quantity of bits represents a quantity of bits of the feedback information in the feedback message. The feedback time interval represents a time interval between sending the uplink data by the terminal device and receiving, by the terminal device, the feedback configuration information sent by the network device. The location index represents a location of a bit of the feedback information in the feedback message.

The uplink resource configuration information indicates a configuration of a transmission resource allocated to the uplink data of the terminal device. The transmission resource includes but is not limited to one or more of a time-frequency resource, a reference signal, a spread spectrum sequence, a scrambling code, and a codebook.

S302. The terminal device determines the transmission resource of the uplink data based on the uplink resource configuration information.

S303. The terminal device sends the uplink data to the network device, and the network device receives the uplink data sent by the terminal device.

The terminal device sends the uplink data based on the transmission resource allocated by the network device.

S304. The network device receives the uplink data, and generates the feedback information.

The network device receives the uplink data, demodulates the uplink data to obtain a demodulation result, where the demodulation result includes two cases: successful demodulation and failed demodulation, and generates the feedback information according to the demodulation result.

It should be noted that the uplink data sent by the terminal device may be lost during an uplink transmission process, and in this case, the network device does not receive the uplink data.

For an embodiment of an implementation process of S304, refer to the description of S203 in FIG. 2a. Details are not described herein again.

S305. The network device sends, to the terminal device, DCI that carries the feedback information, and the terminal device receives the DCI sent by the network device.

The DCI is the feedback message sent by the network device, and the DCI includes feedback information of uplink data transmission of a plurality of terminal devices. The feedback information indicates a status of receiving, by the network device, the uplink data sent by the terminal device, and the feedback information may indicate three statuses: successful demodulation of the uplink data, failed demodulation of the uplink data, and a failure in receiving the uplink data.

S306. The terminal device determines, in the DCI, the feedback information based on the feedback configuration information.

The terminal device determines, in the DCI based on the feedback configuration information received in S301, the receiving status indicated by the feedback information, and determines, based on the receiving status, whether to retransmit the uplink data.

By implementing this embodiment of this application, the terminal device learns, based on the feedback configuration information sent by the network device, the configuration of feedback information. When needing to send the uplink data to the network device, the terminal device can directly obtain, based on the feedback configuration information, the feedback information from the DCI sent by the network device specific to the uplink data, and determine, based on the feedback information, whether retransmission needs to be performed. In this way, the terminal device directly obtains the feedback information from a specified location in the DCI of the network device, and does not need to obtain a location of the feedback information based on a global quantity of pilot sequences and global resource information that are allocated by the network device. Therefore, signaling overheads and a latency of data transmission are reduced.

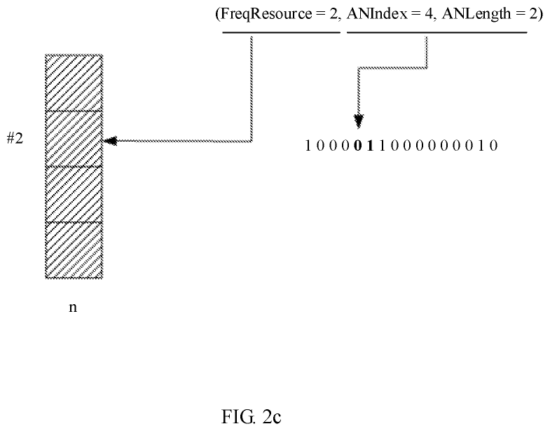

FIG. 4 is another schematic flowchart of a data transmission method according to an embodiment of the present invention. In this embodiment of the present invention, the method includes the following steps.

S401. A network device sends, to a terminal device, higher layer signaling that carries uplink resource configuration information, and the terminal device receives the higher layer signaling sent by the network device.

The uplink resource configuration information indicates a configuration of a transmission resource allocated to the terminal device. The transmission resource includes but is not limited to one or more of a time-frequency resource, a reference signal, a spread spectrum sequence, a scrambling code, and a codebook.

S402. The network device sends, to the terminal device, first DCI that carries feedback configuration information and activation instruction information, and the terminal device receives the first DCI sent by the network device.

The feedback configuration information is used to indicate a configuration of feedback information specific to uplink data of the terminal device, and the terminal device determines, based on the feedback configuration information, the feedback information sent to the terminal device in a feedback message sent by the network device. For example, the feedback configuration information includes one or more of a quantity of bits, a feedback time interval, and a location index. The quantity of bits represents a quantity of bits of the feedback information in the feedback message. The feedback time interval represents a time interval between sending the uplink data by the terminal device and receiving, by the terminal device, the feedback configuration information sent by the network device. The location index represents a location of a bit of the feedback information in the feedback message.

The activation instruction information is at a specified location in the first DCI, and the activation instruction information may use one bit to indicate an activated state and a deactivated state. For example, a bit “1” indicates the activated state, and a bit “0” indicates the deactivated state. The activation instruction information is used to activate the configurations indicated by the uplink resource configuration information and the feedback configuration information.

S403. The terminal device activates the configuration indicated by the uplink resource configuration information and the configuration indicated by the feedback configuration information.

When determining that the bit of the activation instruction information in the first DCI indicates the activated state, the terminal device activates the configurations indicated by the uplink resource configuration information and the feedback configuration information. In this way, after activation, the terminal device can transmit the uplink data by using the transmission resource indicated by the uplink resource configuration information, and determines the feedback information of the uplink data based on the configuration indicated by the feedback configuration information. When the terminal device does not receive the activation instruction information in the first DCI, the configuration indicated by the uplink resource configuration information is in an inactive state. In this case, the terminal device does not use the configuration indicated by the uplink resource configuration information to transmit the uplink data.

S404. The terminal device determines the transmission resource of the uplink data based on the uplink resource configuration information.

S405. The terminal device sends the uplink data to the network device, and the network device receives the uplink data sent by the terminal device.

S406. The network device receives the uplink data, and generates the feedback information.

For an embodiment of an implementation process of S406, refer to the description of S203 in FIG. 2a. Details are not described herein again.

S407. The network device sends, to the terminal device, second DCI that carries the feedback information.

S408. The terminal device determines, in the second DCI, the feedback information based on the feedback configuration information.

The second DCI is the feedback message sent by the network device, and the second DCI includes feedback information of uplink data transmission of a plurality of terminal devices. The terminal device determines, in the second DCI based on the feedback configuration information received in S402, a receiving status indicated by the feedback information, and determines, based on the receiving status, whether to retransmit the uplink data.

By implementing this embodiment of this application, the terminal device learns, based on the feedback configuration information sent by the network device, the configuration of feedback information. When needing to send the uplink data to the network device, the terminal device can directly obtain, based on the feedback configuration information, the feedback information from the DCI sent by the network device specific to the uplink data, and determine, based on the feedback information, whether retransmission needs to be performed. In this way, the terminal device directly obtains the feedback information from a specified location in the DCI of the network device, and does not need to obtain a location of the feedback information based on a global quantity of pilot sequences and global resource information that are allocated by the network device. Therefore, signaling overheads and a latency of data transmission are reduced.

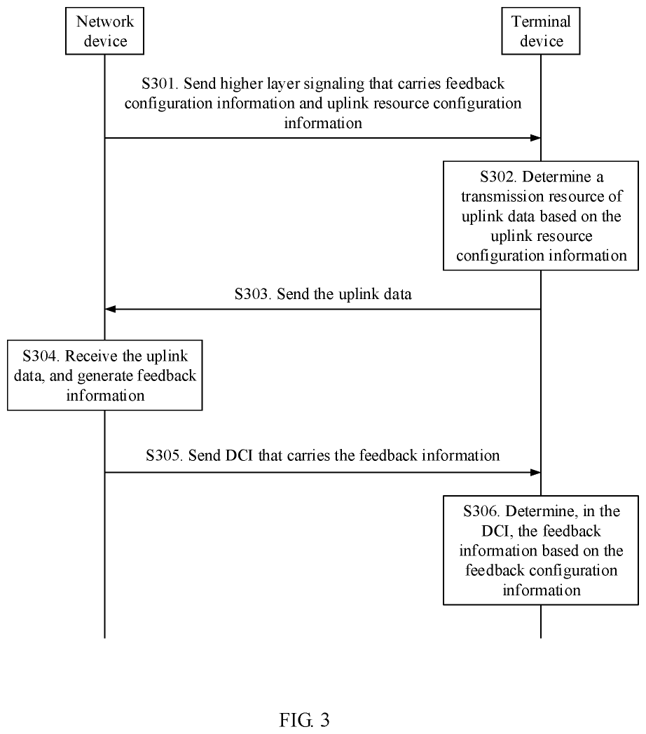

FIG. 5 is another schematic flowchart of a data transmission method according to an embodiment of the present invention. In this embodiment of the present invention, the method includes the following steps.

S501. A network device sends, to a terminal device, higher layer signaling that carries feedback configuration information and uplink resource configuration information, and the terminal device receives the higher layer signaling sent by the network device.

The feedback configuration information is used to indicate a configuration of feedback information specific to uplink data of the terminal device, and the terminal device determines, based on the feedback configuration information, the feedback information sent to the terminal device in a feedback message sent by the network device. For example, the feedback configuration information includes one or more of a quantity of bits, a feedback time interval, and a location index. The quantity of bits represents a quantity of bits of the feedback information in the feedback message. The feedback time interval represents a time interval between sending the uplink data by the terminal and receiving, by the terminal device, the feedback configuration information sent by the network device. The location index represents a location of a bit of the feedback information in the feedback message. The uplink resource configuration information indicates a configuration of a transmission resource allocated to the terminal device. The transmission resource includes but is not limited to one or more of a time-frequency resource, a reference signal, a spread spectrum sequence, a scrambling code, and a codebook.

S502. The network device sends, to the terminal device, first DCI that carries activation instruction information, and the terminal device receives the first DCI sent by the network device.

The activation instruction information is at a specified location (for example, a reserved field) in the first DCI, and the activation instruction information may use one bit to indicate an activated state and a deactivated state. For example, a bit “1” indicates the activated state, and a bit “0” indicates the deactivated state. The activation instruction information is used to activate the configurations indicated by the uplink resource configuration information and the feedback configuration information.

S503. The terminal device activates configurations indicated by the uplink resource configuration information and the feedback configuration information.

When determining that the bit of the activation instruction information in the first DCI indicates the activated state, the terminal device activates the configurations indicated by the uplink resource configuration information and the feedback configuration information. In this way, after activation, the terminal device can transmit the uplink data by using the transmission resource indicated by the uplink resource configuration information, and determines the feedback information of the uplink data based on the feedback configuration information. When the terminal device does not receive the activation instruction information in the first DCI, the configuration indicated by the uplink resource configuration information and the configuration indicated by the feedback configuration information are both in an inactive state. In this case, the terminal device does not use the configuration indicated by the uplink resource configuration information to transmit the uplink data, and does not interpret, based on the configuration indicated by the feedback configuration information, the feedback message sent by the network device to determine the feedback information.

S504. The terminal device determines, based on the uplink resource configuration information, the transmission resource used to transmit the uplink data.

S505. The terminal device sends the uplink data to the network device, and the network device receives the uplink data sent by the terminal device.

S506. The network device receives the uplink data, and generates the feedback information.

For an embodiment of an implementation process of S506, refer to the description of S203 in FIG. 2a. Details are not described herein again.

S507. The network device sends, to the terminal device, second DCI that carries the feedback information, and the terminal device receives the second DCI sent by the network device. The second DCI is the feedback message sent by the network device, and the second DCI includes feedback information specific to uplink data transmission of a plurality of terminal devices.

S508. The terminal device determines, in the second DCI, the feedback information based on the feedback configuration information.

The terminal device determines, in the second DCI based on the feedback configuration information received in S501, a receiving status indicated by the feedback information, and determines, based on the receiving status, whether to retransmit the uplink data.

By implementing this embodiment of this application, the terminal device learns, based on the feedback configuration information sent by the network device, the configuration of feedback information. When needing to send the uplink data to the network device, the terminal device can directly obtain, based on the feedback configuration information, the feedback information from the DCI sent by the network device specific to the uplink data, and determine, based on the feedback information, whether retransmission needs to be performed. In this way, the terminal device directly obtains the feedback information from a specified location in the DCI of the network device, and does not need to obtain a location of the feedback information based on a global quantity of pilot sequences and global resource information that are allocated by the network device. Therefore, signaling overheads and a latency of data transmission are reduced.

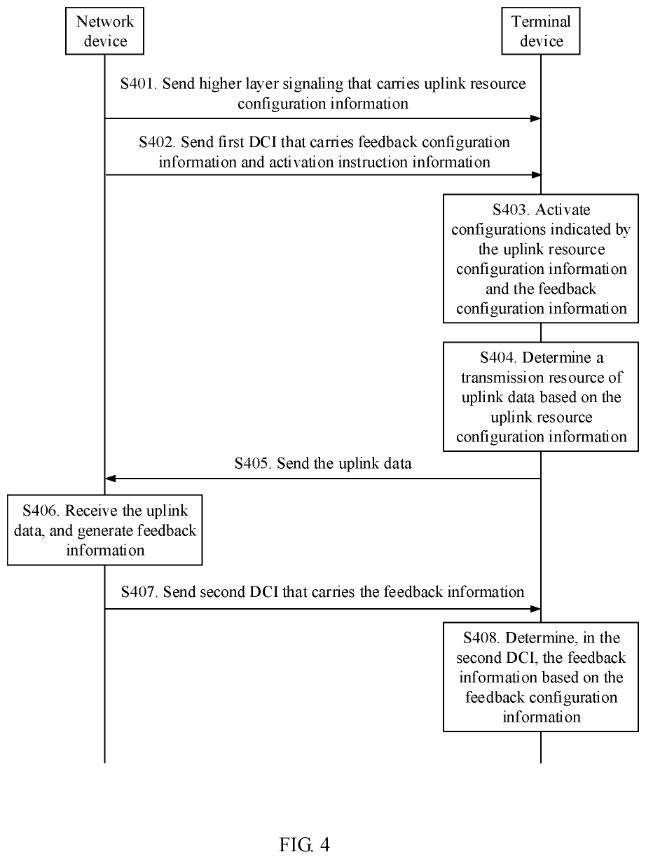

FIG. 6 is another schematic flowchart of a data transmission method according to an embodiment of the present invention. In this embodiment of the present invention, the method includes the following steps.

S601. A network device sends, to a terminal device, higher layer signaling that carries uplink resource configuration information and first feedback configuration information, and the terminal device receives the higher layer signaling sent by the network device.

The first feedback configuration information includes some parameters of feedback configuration information.

S602. The network device sends, to the terminal device, first DCI that carries second feedback configuration information and activation instruction information, and the terminal device receives the first DCI sent by the network device.

The second feedback configuration information includes some parameters of the feedback configuration information. For example, the feedback configuration information includes a quantity of bits, a feedback time interval, and a location index. In an embodiment, the first feedback configuration information includes the quantity of bits, and the second feedback configuration information includes the feedback time interval and the location index. The first feedback configuration information and the second feedback configuration information are used to jointly indicate a configuration of feedback information specific to uplink data of the terminal device. In another embodiment, the first feedback configuration information may include the quantity of bits and the location index, and second feedback configuration information includes the feedback time interval. Alternatively, there may be a plurality of combinations of first feedback configuration information and the second feedback configuration information. This is not limited in this embodiment of the present invention.

S603. The terminal device activates the uplink resource configuration information, the first feedback configuration information, and the second feedback configuration information.

S604. The terminal device determines a transmission resource of the uplink data based on the uplink resource configuration information.

S605. The terminal device sends the uplink data to the network device, and the network device receives the uplink data sent by the terminal device.

S606. The network device receives the uplink data, and generates the feedback information.

For an embodiment of an implementation process of S606, refer to the description of S203 in FIG. 2a. Details are not described herein again.

S607. The network device sends, to the terminal device, second DCI that carries the feedback information.

S608. The terminal device combines the first feedback configuration information and the second feedback configuration information to obtain the feedback configuration information.

For example, according to an example in S602, the feedback configuration information obtained by the terminal device based on the first feedback configuration information and the second feedback configuration information includes three parameters: the quantity of bits, the feedback time interval, and the location index.

S609. The terminal device determines, in the second DCI, the feedback information based on the feedback configuration information.

The terminal device determines, in the second DCI based on the feedback configuration information received in S608, a receiving status indicated by the feedback information, and determines, based on the receiving status, whether to retransmit the uplink data.

By implementing this embodiment of this application, the terminal device learns, based on the feedback configuration information sent by the network device, the configuration of feedback information. When needing to send the uplink data to the network device, the terminal device can directly obtain, based on the feedback configuration information, the feedback information from the DCI sent by the network device specific to the uplink data, and determine, based on the feedback information, whether retransmission needs to be performed. In this way, the terminal device directly obtains the feedback information from a specified location in the DCI of the network device, and does not need to obtain a location of the feedback information based on a global quantity of pilot sequences and global resource information that are allocated by the network device. Therefore, signaling overheads and a latency of data transmission are reduced.

The methods in the embodiments of the present invention are described in detail above, and apparatuses in the embodiments of the present invention are provided below.

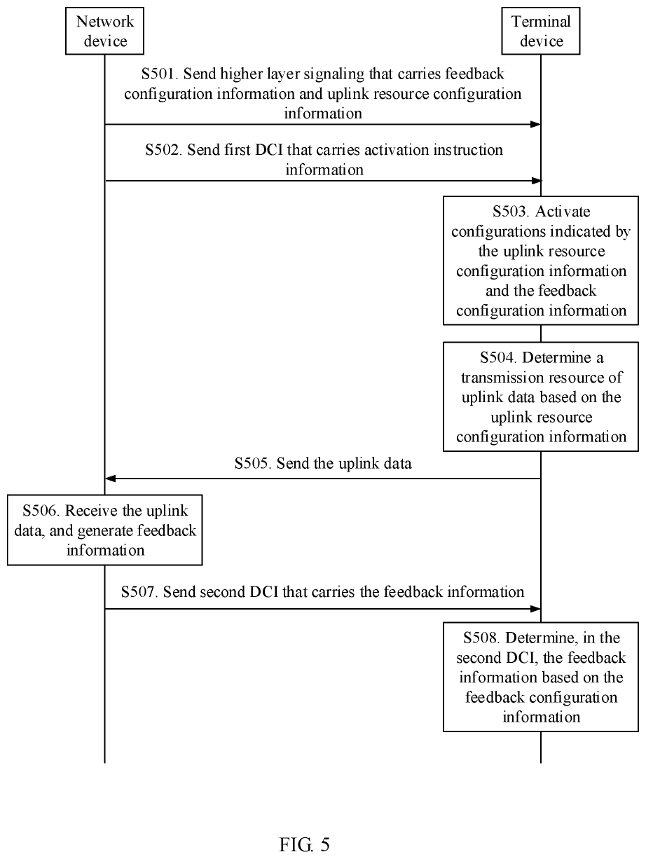

FIG. 7 is a schematic structural diagram of a data transmission apparatus according to an embodiment of the present invention, and the data transmission apparatus may be applied to a system shown in FIG. 1. The data transmission apparatus 7 may include a receiving unit 701, a sending unit 702, and a determining unit 703.

It should be noted that the data transmission apparatus 7 shown in FIG. 7 may implement a function of a terminal device side in the embodiments shown in FIG. 2a to FIG. 6. The receiving unit 701 is configured to receive feedback configuration information from a network device. The feedback configuration information is used to indicate a configuration of feedback information specific to uplink data of the terminal device. The sending unit 702 is configured to send the uplink data to the network device. The determining unit 703 is configured to determine, in a feedback message sent by the network device, the feedback information of the uplink data based on the feedback configuration information. The data transmission apparatus 7 may be a terminal device, or the data transmission apparatus 7 may be a field-programmable gate array (FPGA), a dedicated integrated chip, a system on chip (SoC), a central processing unit (CPU), a network processor (NP), a digital signal processing circuit, or a micro controller unit (MCU) that is configured to implement a related function, or may be a programmable logic device (PLD) or another integrated chip.

For embodiments of implementation of each unit in the data transmission apparatus 7 and implementation of the feedback configuration information, refer to the method embodiments in FIG. 2a to FIG. 6. Details are not described herein again.

This embodiment of the present invention and the method embodiments in FIG. 2a to FIG. 6 are based on a same idea, and bring about same technical effects. For a specific process, refer to the descriptions of the method embodiments in FIG. 2a to FIG. 6. Details are not described herein again.

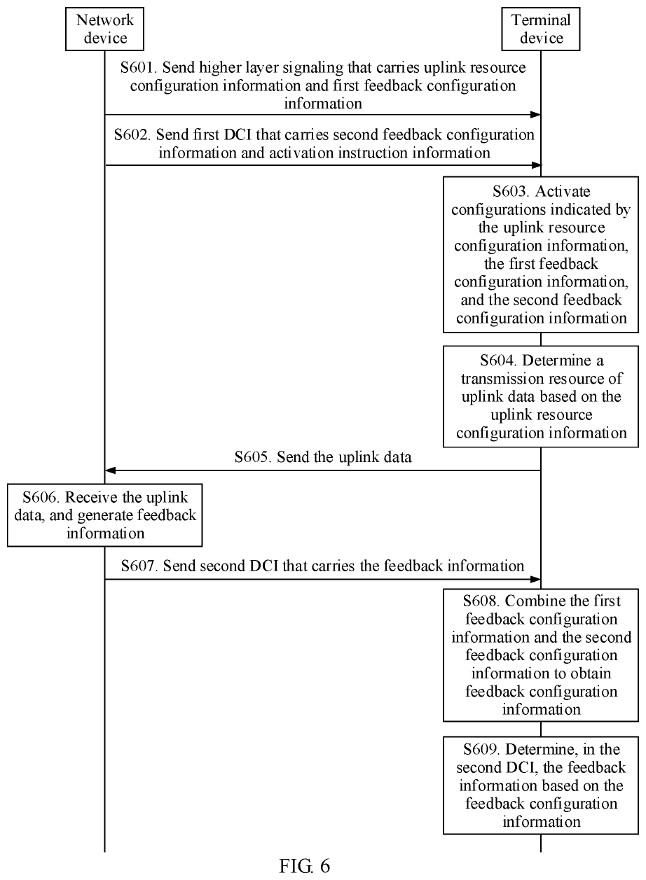

FIG. 8 is a schematic structural diagram of a data transmission feedback apparatus according to an embodiment of the present invention, and the data transmission feedback apparatus may be applied to a system shown in FIG. 1. The data transmission feedback apparatus 8 may be a network device in the system shown in FIG. 1, and may include a sending unit 801 and a receiving unit 802.

It should be noted that the data transmission feedback apparatus 8 shown in FIG. 8 may implement a function of a network device side in the embodiments shown in FIG. 2a to FIG. 6. The sending unit 801 is configured to send feedback configuration information to a terminal device. The feedback configuration information is used to indicate a configuration of feedback information specific to uplink data of the terminal device. The receiving unit 802 is configured to receive the uplink data from the terminal device. The sending unit 801 is further configured to send a feedback message based on the configuration of the feedback information specific to the uplink data of the terminal device. The feedback message carries the feedback information of the uplink data. The data transmission feedback apparatus 8 may be a network device, or the data transmission feedback apparatus 8 may be a field-programmable gate array (FPGA), a dedicated integrated chip, a system on chip (SoC), a central processing unit (CPU), a network processor (NP), a digital signal processing circuit, or a micro controller unit (MCU) that is configured to implement a related function, or may be a programmable logic device (PLD) or another integrated chip.

For embodiments of implementation of each unit in the data transmission feedback apparatus 8 and implementation of the feedback configuration information, refer to the method embodiments in FIG. 2a to FIG. 6. Details are not described herein again.

This embodiment of the present invention and the method embodiments in FIG. 2a to FIG. 6 are based on a same idea, and bring about same technical effects. For a specific process, refer to the descriptions of the method embodiments in FIG. 2a to FIG. 6. Details are not described herein again.

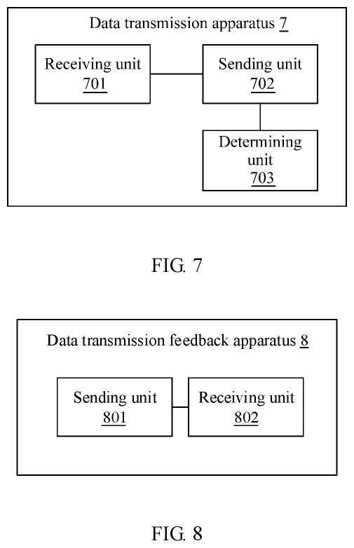

As shown in FIG. 9, an embodiment of the present invention further provides a data transmission apparatus 9.

When the data transmission apparatus 9 is a terminal device, the terminal device includes a processor 901, a memory 902, and a transceiver 903.

The memory 902 is configured to store a program and data. The memory may be a random access memory (RAM), a read only memory (ROM), or a flash memory. The memory 902 may be separately located in a communications device, or may be located in the processor 901.

The transceiver 903 may be used as a separate chip, may be a transceiver circuit in the processor 901, or may be used as an input/output interface. The transceiver 903 is configured to: receive feedback configuration information from a network device, where the feedback configuration information is used to indicate a configuration of feedback information specific to uplink data of the terminal device; send the uplink data to the network device; and receive a feedback message sent by the network device based on the feedback configuration information. For example, the transceiver 903 is configured to perform S201, S202, and S204 in FIG. 2a.

The processor 901 is configured to execute the program code stored in the memory 902, and when the program code is executed, the processor 901 is configured to determine, in the feedback message sent by the network device, the feedback information of the uplink data based on the feedback configuration information. For example, the processor 901 is configured to perform the step S205 in FIG. 2a.

The transceiver 903, the memory 902, and the processor 901 are optionally connected by using a bus.

For embodiments of implementation of each unit in the data transmission apparatus 9 and implementation of the feedback configuration information, refer to the method embodiments in FIG. 2a to FIG. 6. Details are not described herein again.

When the data transmission apparatus 9 is a chip, the chip may be a field programmable gate array, a dedicated integrated chip, a system on chip, a central processing unit, a network processor, a digital signal processing circuit, or a micro controller unit that is configured to implement a related function, or may be a programmable logic device or another integrated chip.

All or some of the foregoing embodiments may be implemented in a form of software, hardware, firmware, or any combination thereof. When a software program is used to implement the embodiments, the embodiments may be implemented completely or partially in a form of a computer program product. The computer program product includes one or more computer instructions. When the computer program instructions are loaded and executed on the computer, the procedure or functions according to the embodiments of this application are all or partially generated. The computer may be a general-purpose computer, a dedicated computer, a computer network, or other programmable apparatuses. The computer instructions may be stored in a computer readable storage medium or may be transmitted from a computer readable storage medium to another computer readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital video disk (DVD)), a semiconductor medium (for example, a solid-state drive (SSD)), or the like.

This embodiment of the present invention and the method embodiments in FIG. 2a to FIG. 6 are based on a same idea, and bring about same technical effects. For a specific process, refer to the descriptions of the method embodiments in FIG. 2a to FIG. 6. Details are not described herein again.

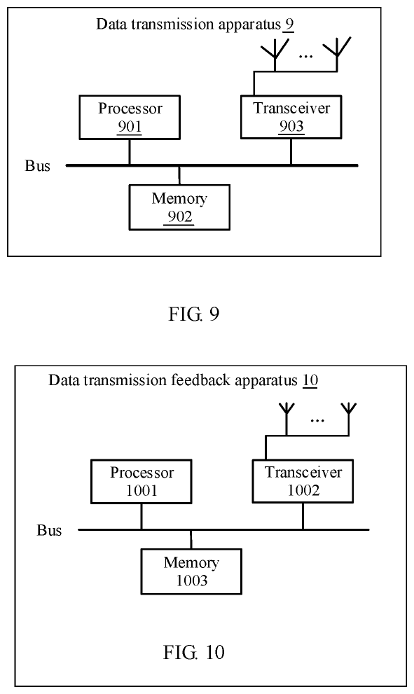

As shown in FIG. 10, an embodiment of the present invention further provides a data transmission feedback apparatus 10.

When the data sending feedback apparatus 10 is a network device, the network device includes a processor 1001, a memory 1002, and a transceiver 1003.

The memory 1002 is configured to store a program and data. The memory may be a random access memory RAM, a ROM, or a flash memory, and the memory 1002 may be separately located in a communications device, or may be located in the processor 1001.

The transceiver 1003 may be used as a separate chip, may be a transceiver circuit in the processor 1001, or may be used as an input/output interface. The transceiver 1003 is configured to: send feedback configuration information to a terminal device, where the feedback configuration information is used to indicate a configuration of feedback information specific to uplink data of the terminal device; receive the uplink data from the terminal device; and send a feedback message based on the configuration of the feedback information specific to the uplink data of the terminal device, where the feedback message carries the feedback information of the uplink data. For example, the transceiver 1003 is configured to perform S201, S202, and S204 in FIG. 2a.

The processor 1001 is configured to execute the step indicated by the program code stored in the memory 1002.

The transceiver 1003, the memory 1002, and the processor 1001 are optionally connected by using a bus.

For embodiments of implementation of each unit in the data transmission apparatus 10 and implementation of the feedback configuration information, refer to the method embodiments in FIG. 2a to FIG. 6. Details are not described herein again.

When the data transmission feedback apparatus 10 is a chip, the chip may be a field programmable gate array, a dedicated integrated chip, a system on chip, a central processing unit, a network processor, a digital signal processing circuit, or a micro controller unit that is configured to implement a related function, or may be a programmable logic device or another integrated chip.
Further embodiments of the present invention are provided in the following. It should be noted that the numbering used in the following section does not necessarily need to comply with the numbering used in the previous sections. The embodiments include, but are not limited to:
   1. A data transmission method, comprising:
   receiving, by a terminal device, feedback configuration information from a network device, wherein the feedback configuration information is used to indicate a configuration of feedback information specific to uplink data of the terminal device;
   sending, by the terminal device, the uplink data to the network device; and
   determining, by the terminal device in a feedback message sent by the network device, the feedback information to the uplink data based on the feedback configuration information.
   2. The method according to embodiment 1, wherein the feedback configuration information comprises one or more of a feedback time interval of the feedback information, a quantity of bits occupied by the feedback information in the feedback message, and a location index of the feedback information in the feedback message.
   3. The method according to embodiment 1 or 2, wherein the receiving, by a terminal device, feedback configuration information from a network device comprises:
   receiving, by the terminal device from the network device, higher layer signaling that carries the feedback configuration information.
   4. The method according to embodiment 3, wherein before the sending, by the terminal device, the uplink data to the network device, the method further comprises:
   receiving, by the terminal device, activation instruction information from the network device; and
   activating, by the terminal device according to the activation instruction information, the configuration indicated by the feedback configuration information.
   5. The method according to embodiment 1 or 2, wherein the receiving, by a terminal device, feedback configuration information from a network device comprises:
   receiving, by the terminal device, downlink control information DCI that carries the feedback configuration information and that is sent by the network device.
   6. The method according to embodiment 1 or 2, wherein the receiving, by a terminal device, feedback configuration information from a network device comprises:
   receiving, by the terminal device, higher layer signaling that carries first feedback configuration information; and
   receiving, by the terminal device, downlink control information DCI that carries second feedback configuration information, wherein
   the first feedback configuration information and the second feedback configuration information jointly indicate the configuration of the feedback information specific to the uplink data of the terminal device.
   7. The method according to any one of embodiments 1 to 6, wherein the feedback message is specifically common downlink control information Common DCI.
   8. A data transmission feedback method, comprising:
   sending, by a network device, feedback configuration information to a terminal device, wherein the feedback configuration information is used to indicate a configuration of feedback information specific to uplink data of the terminal device;
   receiving, by the network device, the uplink data from the terminal device; and
   sending, by the network device, a feedback message based on the configuration of the feedback information specific to the uplink data of the terminal device, wherein the feedback message carries the feedback information to the uplink data.
   9. The method according to embodiment 8, wherein the sending, by a network device, feedback configuration information to a terminal device comprises:
   sending, by the network device to the terminal device, higher layer signaling that carries the feedback configuration information.
   10. The method according to embodiment 9, wherein before the receiving, by the network device, the uplink data from the terminal device, the method further comprises:
   sending, by the network device, activation instruction information to the terminal device, wherein the activation instruction information is used to instruct the terminal device to activate the configuration indicated by the feedback configuration information.
   11. The method according to embodiment 8 or 9, wherein the sending, by a network device, feedback configuration information to a terminal device comprises:
   sending, by the network device to the terminal device, downlink control information DCI that carries the feedback configuration information.
   12. The method according to embodiment 8 or 9, wherein the sending, by a network device, feedback configuration information to a terminal device comprises:
   sending, by the network device to the terminal device, higher layer signaling that carries first feedback configuration information; and
   sending, by the network device to the terminal device, downlink control information that carries second feedback configuration information, wherein
   the first feedback configuration information and the second feedback configuration information jointly indicate the configuration of the feedback information specific to the uplink data of the terminal device.
   13. The method according to any one of embodiments 7 to 12, wherein the feedback message is specifically common downlink control information Common DCI.
   14. A data transmission apparatus, comprising:
   a receiving unit, configured to receive feedback configuration information from a network device, wherein the feedback configuration information is used to indicate a configuration of feedback information specific to uplink data of a terminal device;
   a sending unit, configured to send the uplink data to the network device; and
   a determining unit, configured to determine, in a feedback message sent by the network device, the feedback information to the uplink data based on the feedback configuration information.
   15. The apparatus according to embodiment 14, wherein the feedback configuration information comprises one or more of a feedback time interval of the feedback information, a quantity of bits occupied by the feedback information in the feedback message, and a location index of the feedback information in the feedback message.
   16. The apparatus according to embodiment 14 or 15, wherein the receiving unit is configured to
   receive, from a network device, higher layer signaling that carries the feedback configuration information.
   17. The apparatus according to embodiment 16, wherein
   the receiving unit is further configured to receive activation instruction information from the network device; and
   the determining unit is specifically configured to:
   determine, in the feedback message sent by the network device, the feedback information to the uplink data based on the configuration indicated by the activated feedback configuration information, wherein the configuration indicated by the feedback configuration information is activated after the activation instruction information is received.
   18. The apparatus according to embodiment 14 or 15, wherein the receiving unit is configured to receive downlink control information DCI that carries the feedback configuration information and that is sent by the network device.
   19. The apparatus according to embodiment 14 or 15, wherein the receiving unit is configured to receive higher layer signaling that carries first feedback configuration information; and
   receiving downlink control information DCI that carries second feedback configuration information, wherein
   the first feedback configuration information and the second feedback configuration information jointly indicate the configuration of the feedback information specific to the uplink data of the terminal device.
   20. The apparatus according to any one of embodiments 14 to 19, wherein the feedback message is specifically common downlink control information Common DCI.
   21. A data transmission feedback apparatus, comprising:
   a sending unit, configured to send feedback configuration information to a terminal device, wherein the feedback configuration information is used to indicate a configuration of feedback information specific to uplink data of the terminal device; and
   a receiving unit, configured to receive the uplink data from the terminal device, wherein
   the sending unit is further configured to send a feedback message based on the configuration of the feedback information specific to the uplink data of the terminal device, wherein the feedback message carries the feedback information of the uplink data.
   22. The apparatus according to embodiment 21, wherein that the sending unit is configured to send, to the terminal device, higher layer signaling that carries the feedback configuration information.
   23. The apparatus according to embodiment 22, wherein the sending unit is further configured to send activation instruction information to the terminal device, wherein the activation instruction information is used to instruct the terminal device to activate the configuration indicated by the feedback configuration information.
   24. The apparatus according to embodiment 21 or 22, wherein the sending unit is configured to send, to the terminal device, downlink control information DCI that carries the feedback configuration information.
   25. The apparatus according to embodiment 21 or 22, wherein the sending unit is configured to send, to the terminal device, higher layer signaling that carries first feedback configuration information; and
   sending, to the terminal device, downlink control information that carries second feedback configuration information, wherein
   the first feedback configuration information and the second feedback configuration information jointly indicate the configuration of the feedback information specific to the uplink data of the terminal device.
   26. The apparatus according to any one of embodiments 21 to 25, wherein the feedback message is specifically common downlink control information Common DCI.
   27. A computer readable storage medium, wherein the computer readable storage medium stores a computer program or an instruction, and when the computer program or the instruction is executed, the method according to any one of embodiments 1 to 13 is implemented.
   28. A computer program product, wherein the computer program product comprises an instruction, and when the computer program product runs on a computer, the computer is enabled to perform the method according to any one of embodiments 1 to 13.
   29. An apparatus, comprising a processor and a transceiver, wherein the processor is coupled to the transceiver, and the processor is configured to execute a computer program or instruction, to control the transceiver to receive and send information; and when the processor executes the computer program or instruction, the processor is further configured to implement the method according to any one of embodiments 1 to 13.

All or some of the foregoing embodiments may be implemented in a form of software, hardware, firmware, or any combination thereof. When a software program is used to implement the embodiments, the embodiments may be implemented completely or partially in a form of a computer program product. The computer program product includes one or more computer instructions. When the computer program instructions are loaded and executed on the computer, the procedure or functions according to the embodiments of this application are all or partially generated. The computer may be a general-purpose computer, a dedicated computer, a computer network, or other programmable apparatuses. The computer instructions may be stored in a computer readable storage medium or may be transmitted from a computer readable storage medium to another computer readable storage medium. For example, the computer instructions may be transmitted from a website, computer, server, or data center to another website, computer, server, or data center in a wired (for example, a coaxial cable, an optical fiber, or a DSL) or wireless (for example, infrared, radio, or microwave) manner. The computer readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a SSD), or the like.

This embodiment of the present invention and the method embodiments in FIG. 2a to FIG. 6 are based on a same idea, and bring about same technical effects. For a specific process, refer to the descriptions of the method embodiments in FIG. 2a to FIG. 6. Details are not described herein again.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

All or some of the foregoing embodiments may be implemented in a form of software, hardware, firmware, or any combination thereof. When software is used to implement the embodiments, the embodiments may be implemented completely or partially in a form of a computer program product. The computer program product includes one or more computer instructions. When the computer program instructions are loaded and executed on the computer, the procedure or functions according to the embodiments of the present invention are all or partially generated. The computer may be a general-purpose computer, a dedicated computer, a computer network, or other programmable apparatuses. The computer instructions may be stored in a computer readable storage medium or may be transmitted by using the computer readable storage medium. The computer instructions may be transmitted from a website, computer, server, or data center to another website, computer, server, or data center in a wired (for example, a coaxial cable, an optical fiber, or a DSL) or wireless (for example, infrared, radio, or microwave) manner. The computer readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a SSD), or the like.

A person of ordinary skill in the art may understand that all or some of the processes of the methods in the embodiments may be implemented by a computer program instructing related hardware. The program may be stored in a computer readable storage medium. When the program runs, the processes of the methods in the embodiments are performed. The foregoing storage medium includes: any medium that can store program code, such as a read only memory (ROM) or a random access memory (RAM), a magnetic disk, an optical disc, or the like.

1. A data transmission feedback method, comprising:
sending, by a network device, feedback configuration information to a terminal device, wherein the feedback configuration information indicates a configuration of feedback information specific to uplink data of the terminal device;
receiving, by the network device, the uplink data from the terminal device; and
sending, by the network device, a feedback message based on the configuration of the feedback information specific to the uplink data of the terminal device, wherein the feedback message carries the feedback information to the uplink data.

2. The method according to claim 1, wherein the sending, by the network device, feedback configuration information to the terminal device comprises:
sending, by the network device to the terminal device, higher layer signaling that carries the feedback configuration information.

3. The method according to claim 2, wherein before the receiving, by the network device, the uplink data from the terminal device, the method further comprises:
sending, by the network device, activation instruction information to the terminal device, wherein the activation instruction information instructs the terminal device to activate the configuration indicated by the feedback configuration information.

4. The method according to claim 1, wherein the sending, by the network device, feedback configuration information to the terminal device comprises:
sending, by the network device to the terminal device, downlink control information (DCI) that carries the feedback configuration information.

5. The method according to claim 1, wherein the sending, by the network device, feedback configuration information to the terminal device comprises:
sending, by the network device to the terminal device, higher layer signaling that carries first feedback configuration information; and
sending, by the network device to the terminal device, downlink control information that carries second feedback configuration information, wherein
the first feedback configuration information and the second feedback configuration information jointly indicate the configuration of the feedback information specific to the uplink data of the terminal device.

6. The method according to claim 1, wherein the feedback message is Common DCI.

7. A data transmission apparatus, comprising:
a transceiver configured to:
receive feedback configuration information from a network device, wherein the feedback configuration information indicates a configuration of feedback information specific to uplink data of a terminal device, and
send the uplink data to the network device; and
a processor communicatively coupled with the transceiver, configured to determine, in a feedback message sent by the network device, the feedback information to the uplink data based on the feedback configuration information.

8. The apparatus according to claim 7, wherein the feedback configuration information comprises one or more of a feedback time interval of the feedback information, a quantity of bits occupied by the feedback information in the feedback message, and a location index of the feedback information in the feedback message.

9. The apparatus according to claim 7, wherein the transceiver is configured to:
receive, from a network device, higher layer signaling that carries the feedback configuration information.

10. The apparatus according to claim 9, further comprising:
the transceiver further configured to receive activation instruction information from the network device; and
the processor further configured to determine, in the feedback message sent by the network device, the feedback information to the uplink data based on the configuration indicated by the activated feedback configuration information, wherein the configuration indicated by the feedback configuration information is activated after the activation instruction information is received.

11. The apparatus according to claim 7, wherein the transceiver is configured to receive downlink control information (DCI) that carries the feedback configuration information and that is sent by the network device.

12. The apparatus according to claim 7, wherein the transceiver is configured to:
receive higher layer signaling that carries first feedback configuration information; and
receiver DCI that carries second feedback configuration information, wherein
the first feedback configuration information and the second feedback configuration information jointly indicate the configuration of the feedback information specific to the uplink data of the terminal device.

13. The apparatus according to claim 7, wherein the feedback message is Common DCI.

14. A data transmission feedback apparatus, comprising:
a processor; and
a transceiver, communicatively coupled with the processor, configured to:
send feedback configuration information to a terminal device, wherein the feedback configuration information indicates a configuration of feedback information specific to uplink data of the terminal device, and
receive the uplink data from the terminal device, and
send a feedback message based on the configuration of the feedback information specific to the uplink data of the terminal device, wherein the feedback message carries the feedback information of the uplink data.

15. The apparatus according to claim 14, wherein that the transceiver is configured to send, to the terminal device, higher layer signaling that carries the feedback configuration information.

16. The apparatus according to claim 15, wherein the transceiver is further configured to send activation instruction information to the terminal device, wherein the activation instruction information instructs the terminal device to activate the configuration indicated by the feedback configuration information.

17. The apparatus according to claim 14, wherein the transceiver is configured to send, to the terminal device, downlink control information (DCI) that carries the feedback configuration information.

18. The apparatus according to claim 14, wherein the transceiver is configured to:
send, to the terminal device, higher layer signaling that carries first feedback configuration information; and
send, to the terminal device, downlink control information that carries second feedback configuration information, wherein
the first feedback configuration information and the second feedback configuration information jointly indicate the configuration of the feedback information specific to the uplink data of the terminal device.

19. The apparatus according to claim 14, wherein the feedback message is Common DCI.
